(19) United States
(12) Patent Application Publication
(10) Pub. No.: US 2017/0318356 A1
(43) Pub. Date: Nov. 2, 2017

(54) DATA DELIVERY SYSTEM AND METHOD

(71) Applicant: DINGMEDIA LTD, London (GB)

(72) Inventor: Robert James Mark Hain, Sanremo (IT)

(73) Assignee: DINGMEDIA LTD, London (GB)

(21) Appl. No.: 15/585,120

(22) Filed: May 2, 2017

Related U.S. Application Data
(60) Provisional application No. 62/330,818, filed on May 2, 2016.

(30) Foreign Application Priority Data
May 2, 2016 (GB) 1607644.0

(51) Int. Cl. H04N 21/81; H04N 21/435; G06Q 30/02

(52) U.S. Cl. CPC H04N 21/812; H04N 21/435; G06Q 30/0277

(57) ABSTRACT

There is provided a data delivery system (10) for providing multimedia content data to users, wherein the data delivery system (10) includes a data server arrangement (120) for supplying the multimedia content data to the users, an advertisement content data server arrangement (140) for providing advertisement content data to the users, and a control centre arrangement for coordinating supply of the multimedia content data and the advertisement content data to the users. The users have spatially locally thereto computing hardware and associated display hardware for presenting the multimedia content data and the advertisement content data received at the users, wherein the computing hardware is operable to execute program instructions (50, 60) for presenting the multimedia content data and the advertisement content data received at the users. The program instructions (50, 60) are operable to cause the computing hardware to report to the advertisement content data server arrangement (140) an operating status and data processing capability of the computing hardware and associated display hardware, and the advertisement content data server arrangement (140) is operable to select advertisement data content for supplying to the users, customized for each user, depending upon the operating status and data processing capability, as well as a profitability associated with selecting the advertisement data content.

### CROSS-REFERENCE TO RELATED APPLICATIONS

This application claims the benefit of U.S. Provisional Patent Application No. 62/330,818, filed May 2, 2016, the entire disclosure of which is incorporated herein by reference. This application also claims the benefit of UK Application No.: GB1607644.0, filed on May 2, 2016, which is hereby incorporated by reference in its entirety.

### TECHNICAL FIELD

The present disclosure relates to data delivery systems for delivering data to users, for example a data delivery system that is operable to supply data such as advertisement content, in a more technically suitable and economically profitable manner to users of the data delivery systems; such “technically suitable” manner includes delivering content more promptly to users, or reducing a need for users to wait to receive given content. Moreover, the present disclosure concerns method of using aforesaid data delivery systems for delivering data to users such as advertisement content, in a more technically suitable and economically profitable manner to users of the data delivery systems. Furthermore, the present disclosure is concerned with computer program products comprising a non-transitory computer-readable storage medium having computer-readable instructions stored thereon, the computer-readable instructions being executable by a computerized device comprising processing hardware to execute aforesaid methods.

### BACKGROUND

Data delivery systems such as server arrangements coupled via the contemporary Internet® operating under Transmission Control Protocol/Internet Protocol (TCP/IP) to users' browsing apparatuses are known. Such data delivery systems make possible viewing of multimedia content via the Internet®, for example as in YOUTUBE® and similar multimedia content platforms. Many such content delivery platforms have associated business models that require delivery of paid advertisement content concurrently with streaming multimedia content. However, in the contemporary Internet®, many data feeds from server arrangements are provided inappropriately for users' browsing apparatuses, such that Internet® bandwidth, server capacity and data supply efficiency are often considerably sub-optimal. As a result, advertising profitability per user is reduced. Such sub-optimal delivery includes, for example, users having to wait a period for advertisement content to provided, wherein, during the period, the users' browsers appear to “hang”, causing user irritation and causing users to be disinterested in advertisement content shown to them. It should be appreciated that a temporal delay in transmission and corresponding reception of given content is an objective technical problem that the present disclosure seeks to address.

Contemporary broadcasters delivering data via the Internet® struggle to deliver advertisement-funded video content through their own sites and software applications (“apps”) due to a lack of a cost-effective solution for such data delivery. Incumbent platforms such as FACEBOOK® and the aforesaid YOUTUBE® and have become the de facto solution for multimedia content delivery via the Internet® to users, but have a tendency to reduce profit margins of other multimedia data providers and take audiences off-site in respect of these other multimedia data providers. Both YOUTUBE® and FACEBOOK® take circa 45% of advertisement revenue in commission, significantly affecting revenues of other multimedia data providers.

Attempting to implement an alternative form of data delivery system requires integrating multiple services, which is risky, complex and can result in drastic performance issues that further affect monetization, namely business model revenues. Thus, there arises a technical problem of providing an improved data delivery system that is able to address limitations exhibited by known data delivery platforms such as the inefficiency when delivering advertisement content to users' browsing apparatuses; such inefficiency concerns, for example, one or more delays when delivering given content to users' browsers.

It will be appreciated from the foregoing that content data supplying arrangements in contemporary data communication networks such as the Internet®, namely “waterfalls”, are vertical (for example, as in known contemporary LiveRail®, Ooyala®, Google DFP (DoubleClick for Publishers), AdSense®, and similar platforms) and have some physical restrictions because of such verticality. Such contemporary data supplying arrangements are not profitable (around 25% of fill rate) implementations on the market for filling content and therefore most operators of data delivery platforms in contemporary industry lose money. Currently known implementations provide certain fixed advertisement (‘ad’) slots where a given user either fits or does not fit. The principal technical problems of latency and load on users' browsers arises therefrom wherein a given user has to wait for all associated Ad requests to either come back or time out. Once the first few slots of ad space have been rejected, they might also time out and leave the ad place empty, resulting in high inefficiency. The more requests there are, the higher the risk of time out resulting in a low fill rate. A low fill rate corresponds to a loss in revenue and also technically inefficient use of data communication system resources.

### SUMMARY

The present disclosure seeks to provide an improved data delivery system that is able to deliver data more efficiently and in a more acceptable manner via a data communication network, such as via the Internet, to users, thereby attaining increased user loyalty.

Moreover, the present disclosure seeks to provide a data delivery system that is capable of providing its operator with a higher average revenue per user (ARPU), thereby providing the operator with higher profits margins and with less data flow being required.

Furthermore, the present disclosure seeks to provide an improved method of providing multimedia data to users, using the aforementioned improved data delivery system.

According to a first aspect, there is provided a data delivery system for providing multimedia content data to users, wherein the data delivery system includes a data server arrangement for supplying the multimedia content data to the users, an advertisement content data server arrangement for providing advertisement content data to the users, and a control centre arrangement for coordinating supply of the multimedia content data and the advertisement content data to the users, characterized in that the users have spatially locally thereto computing hardware and associated display hardware for presenting the multimedia content data and the advertisement content data received at the users, wherein the computing hardware is operable to execute program instructions for presenting the multimedia content data and the advertisement content data received at the users; and wherein the program instructions are operable to cause the computing hardware to report to the advertisement content data server arrangement an operating status and data processing capability of the computing hardware and associated display hardware, and the advertisement content data server arrangement is operable to select advertisement data content for supplying to the users, customized for each user, depending upon the operating status and data processing capability, as well as a profitability associated with selecting the advertisement data content.

The present invention is of advantage in that the data delivery system is able to provide a more efficient and profitable data “waterfall”, by ensuring that slots for each given user of the data delivery system are more efficiently filled and communicated to users of the data delivery system; namely, in other words, data is not wasted within the delivery system and its energy consumption when communicating data is correspondingly reduced.

Optionally, in the data delivery system, the advertisement content data server arrangement is operable to employ an ad stack module for selecting the advertisement data content, wherein the operating status and data processing capability, as well as a profitability associated with selecting the advertisement data content, are indicative of one or more of:

(i) an indication of advertisement content data that can be most economically beneficially, in respect of an operator of the data delivery system, be delivered via the computing hardware and associated display hardware to a given associated user;
(ii) a capability of the program instructions, being executed on associated computing hardware to process received content data thereat, of presenting the multimedia content data and the advertisement content data received at the users whether or not there are media incompatibility issues or encoding format incompatibility issues that prevent given content data being presented;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

Optionally, in the data delivery system, the multimedia content data and the advertisement content data, when received at the data delivery system are processed in real-time at a broadcast application arrangement and stored in the data server arrangement.

More optionally, the data delivery system provides in operation a customer-portal for enabling the customers to upload multimedia content data and/or advertisement content data via the broadcast application arrangement to the data server arrangement.

More optionally, the data delivery system provides in operation the customer-portal for enabling customers to review multimedia content data and/or advertisement content data that has been uploaded by the customers via the broadcast application arrangement to the data server arrangement.

More optionally, the data delivery system is operable to collate and report statistical data representative of showings of multimedia content data and/or advertisement data, uploaded by the customers to the data delivery system, to the users.

According to a second aspect, there is provided a method of using a data delivery system for providing multimedia content data to users, wherein the data delivery system includes a data server arrangement for supplying the multimedia content data to the users, an advertisement content data server arrangement for providing advertisement content data to the users, and a control centre arrangement for coordinating supply of the multimedia content data and the advertisement content data to the users, characterized in that the method includes:

(i) arranging for the users to have spatially locally thereto computing hardware and associated display hardware for presenting the multimedia content data and the advertisement content data received at the users, wherein the computing hardware is operable to execute program instructions for presenting the multimedia content data and the advertisement content data received at the users; and
(ii) arranging for the program instructions to be operable to cause the computing hardware to report to the advertisement content data server arrangement an operating status and data processing capability of the computing hardware and associated display hardware, and for the advertisement content data server arrangement to be operable to select advertisement data content for supplying to the users, customized for each user, depending upon the operating status and data processing capability as well as a profitability associated with selecting the advertisement data content.

Optionally, the method includes arranging for the advertisement content data server arrangement to be operable to employ an ad stack module for selecting the advertisement data content, wherein the operating status and data processing capability, as well as a profitability associated with selecting the advertisement data content, are indicative or one or more of:

(i) an indication of advertisement content data that can be most economically beneficially, in respect of an operator of the data delivery system, be delivered via the computing hardware and associated display hardware to a given associated user;
(ii) a capability of the program instructions, being executed on associated computing hardware to process received content data thereat, of rendering and presenting the multimedia content data and the advertisement content data received at the users whether or not there are media incompatibility issues or encoding format incompatibility issues that prevent given content data being rendered;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

Optionally, in the method, the multimedia content data and the advertisement content data, when received at the data delivery system are processed in real-time at a broadcast application arrangement and stored in the data server arrangement.

Optionally, the method includes arranging for the data delivery system to provide in operation a customer-portal for enabling the customers to upload multimedia content data and/or advertisement content data via the broadcast application arrangement to the data server arrangement.

More optionally, the method includes arranging for the data delivery system to provide in operation the customer-portal for enabling customers to review multimedia content data and/or advertisement content data that has been uploaded by the customers via the broadcast application arrangement to the data server arrangement.

More optionally, the method includes arranging for the data delivery system to be operable to collate and report statistical data representative of showings of multimedia content data and/or advertisement data, uploaded by the customers to the data delivery system, to the users.

According to a third aspect, there is provided an ad stack module for use with the aforementioned data delivery system, characterized in that an ad stack module is operable to select advertisement data content, in response to receiving data indicative of a given user operating status and data processing capability, as well as a profitability associated with selecting the advertisement data content for the given user, wherein the received data includes:

(i) an indication of advertisement content data that can be most economically beneficially, in respect of an operator of the data delivery system, be delivered via the computing hardware and associated display hardware to a given associated user;
(ii) a capability of the program instructions, being executed on associated computing hardware to process received content data thereat, of presenting the multimedia content data and the advertisement content data received at the users whether or not there are media incompatibility issues or encoding format incompatibility issues that prevent given content data being presented;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

According to a fourth aspect, there is provided a computer program products comprising a non-transitory computer-readable storage medium having computer-readable instructions stored thereon, the computer-readable instructions being executable by a computerized device comprising processing hardware to execute a method of the second aspect.

It will be appreciated that features of the invention are susceptible to being combined in various combinations without departing from the scope of the invention as defined by the appended claims.

### BRIEF DESCRIPTION OF THE DRAWINGS

Embodiments of the present invention will now be described, by way of example only, with reference to the following diagrams wherein:

FIG. 1 is a schematic illustration of a data delivery system pursuant to the present disclosure;

FIG. 2 is a schematic illustration of a web-player, of the data delivery system of FIG. 1;

FIG. 3 is a schematic illustration of a mobile player of the data delivery system of FIG. 1;

FIG. 4 is a more detailed illustration of functional elements of the data delivery system of FIG. 1;

FIG. 5 is an illustration of a control panel displayed on a graphical user interface (GUI) of a customer of the data delivery system of FIG. 1;

FIG. 6 is an illustration of a GUI invitation for file uploading by a customer of the data content system of FIG. 1;

FIG. 7 is an illustration file uploading is implemented by the customer of FIG. 6, using the Broadcast App from a LIQUIDSTREAM® portal if the data content system of FIG. 1;

FIG. 8 is a schematic illustration of a Broadcast App interface, wherein the Broadcast App encodes and uploads files in parallel to deliver content data as quickly and efficiently as possible within the data delivery system of FIG. 1, notifying the customer when a queue of broadcast tasks instructed by the customer has been processed; and

FIG. 9 is an illustration of a flow chart depicting steps of a method of operating the data delivery system of FIG. 4.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, in a first aspect, there is provided a data delivery system for providing multimedia content data to users, wherein the data delivery system includes a data server arrangement for supplying the multimedia content data to the users, an advertisement content data server arrangement for providing advertisement content data to the users, and a control centre arrangement for coordinating supply of the multimedia content data and the advertisement content data to the users,

characterized in that the users have spatially locally thereto computing hardware and associated display hardware for presenting the multimedia content data and the advertisement content data received at the users, wherein the computing hardware is operable to execute program instructions for presenting the multimedia content data and the advertisement content data received at the users; and
wherein the program instructions are operable to cause the computing hardware to report to the advertisement content data server arrangement an operating status and data processing capability of the computing hardware and associated display hardware, and the advertisement content data server arrangement is operable to select advertisement data content for supplying to the users, customized for each user, depending upon the operating status and data processing capability, as well as a profitability associated with selecting the advertisement data content.

Optionally, in the data delivery system, the advertisement content data server arrangement is operable to employ an ad stack module for selecting the advertisement data content, wherein the operating status and data processing capability, as well as a profitability associated with selecting the advertisement data content, are indicative or one or more of:
(i) an indication of advertisement content data that can be most economically beneficially, in respect of an operator of the data delivery system, be delivered via the computing hardware and associated display hardware to a given associated user;
(ii) a capability of the program instructions, being executed on associated computing hardware to process received content data thereat, of presenting the multimedia content data and the advertisement content data received at the users, whether or not there are media incompatibility issues or encoding format incompatibility issues that prevent given content data being presented;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

Optionally, in the data delivery system, the multimedia content data and the advertisement content data, when received at the data delivery system are processed in real-time at a broadcast application arrangement and stored in the data server arrangement.

More optionally, the data delivery system provides in operation a customer-portal for enabling the customers to upload multimedia content data and/or advertisement content data via the broadcast application arrangement to the data server arrangement.

More optionally, the data delivery system provides in operation the customer-portal for enabling customers to review multimedia content data and/or advertisement content data that has been uploaded by the customers via the broadcast application arrangement to the data server arrangement.

More optionally, the data delivery system is operable to collate and report statistical data representative of showings of multimedia content data and/or advertisement data, uploaded by the customers to the data delivery system, to the users.

According to a second aspect, there is provided a method of using a data delivery system for providing multimedia content data to users, wherein the data delivery system includes a data server arrangement for supplying the multimedia content data to the users, an advertisement content data server arrangement for providing advertisement content data to the users, and a control centre arrangement for coordinating supply of the multimedia content data and the advertisement content data to the users, characterized in that the method includes:
(i) arranging for the users to have spatially locally thereto computing hardware and associated display hardware for presenting the multimedia content data and the advertisement content data received at the users, wherein the computing hardware is operable to execute program instructions for presenting the multimedia content data and the advertisement content data received at the users; and
(ii) arranging for the program instructions to be operable to cause the computing hardware to report to the advertisement content data server arrangement an operating status and data processing capability of the computing hardware and associated display hardware, and the advertisement content data server arrangement to be operable to select advertisement data content for supplying to the users, customized for each user, depending upon the operating status and data processing capability, as well as a profitability associated with selecting the advertisement data content.

Optionally, the method includes arranging for the advertisement content data server arrangement to be operable to employ an ad stack module for selecting the advertisement data content, wherein the operating status and data processing capability, as well as a profitability associated with selecting the advertisement data content, are indicative or one or more of:
(i) an indication of advertisement content data that can be most economically beneficially, in respect of an operator of the data delivery system), be delivered via the computing hardware and associated display hardware to a given associated user;
(ii) a capability of the program instructions, being executed on associated computing hardware to process received content data thereat, of rendering and presenting the multimedia content data and the advertisement content data received at the users whether or not there are media incompatibility issues or encoding format incompatibility issues that prevent given content data being rendered;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

Optionally, in the method, the multimedia content data and the advertisement content data, when received at the data delivery system are processed in real-time at a broadcast application arrangement and stored in the data server arrangement.

Optionally, the method includes arranging for the data delivery system to provide in operation a customer-portal for enabling the customers to upload multimedia content data and/or advertisement content data via the broadcast application arrangement to the data server arrangement.

More optionally, the method includes arranging for the data delivery system to provide in operation the customer-portal for enabling customers to review multimedia content data and/or advertisement content data that has been uploaded by the customers via the broadcast application arrangement to the data server arrangement.

More optionally, the method includes arranging for the data delivery system to be operable to collate and report statistical data representative of showings of multimedia content data and/or advertisement data, uploaded by the customers to the data delivery system, to the users.

According to a third aspect, there is provided an ad stack module for use with the aforementioned data delivery system, characterized in that an ad stack module is operable to select advertisement data content, in response to receiving data indicative of a given user operating status and data processing capability, as well as a profitability associated with selecting the advertisement data content for the given user, wherein the received data includes:
(i) an indication of advertisement content data that can be most economically beneficially, in respect of an operator of the data delivery system, be delivered via the computing hardware and associated display hardware to a given associated user;
(ii) a capability of the program instructions, being executed on associated computing hardware to process received content data thereat, of presenting the multimedia content data and the advertisement content data received at the users whether or not there are media incompatibility issues, encoding format incompatibility issues that prevent given content data being presented;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

According to a fourth aspect, there is provided a computer program products comprising a non-transitory computer-readable storage medium having computer-readable instructions stored thereon, the computer-readable instructions being executable by a computerized device comprising processing hardware to execute a method of the second aspect.

User Datagram Protocol (“UDP”) is an alternative contemporary protocol to Transmission Control Protocol (“TCP”) that is often used when communicating data via the contemporary Internet®. UDP is used primary for establishing low-latency and loss-tolerating communication connections between applications on the Internet. Both UDP and TCP run on top of Internet Protocol (“IP”), and are sometimes referred to as “UDP/IP” and “TCP/IP”. Both of these two protocols send short packets of data, called “datagrams” TCP has emerged as a dominant protocol used for a bulk of Internet® connectivity owing to services for breaking large data sets into individual packets, checking and resending lost packets and reassembling packets into a correct sequence. However, such services come at a cost in terms of additional data overhead, and latency delays. In contradistinction, UDP just sends data packets, that means that it has a much lower bandwidth overhead and latency in comparison to TCP/IP. Nevertheless, with UDP, data packets can be lost or received in an incorrect order, owing to mutually different potential paths that individual data packets traverse when propagating through the Internet from a given sender to a given receiver.

Aforesaid UDP is an ideal protocol for network applications in which perceived latency is critical, such as gaming applications and voice-and-video communication applications that can suffer some data loss without adversely affecting perceived quality at a given receiver. Optionally, forward error correction techniques are used to improve audio and video quality, despite some loss of data during transmission through the Internet®.

In an Open Systems Interconnection (OSI) communication model, UDP and TCP are in layer 4, also known as a “transport layer”. Thus, UDP is operable to work in conjunction with high level protocols to help manage data transmission services including, for example, Trivial File Transfer Protocol (“TFTP”), Real Time Streaming Protocol (“RTSP”), Simple Network Protocol (“SNP”) and Domain Name System (“DNS”) look-ups.

A datagram is a self-contained, independent entity of data carrying sufficient information to be routed from a given sender such as a data source, to a given receiver such as a destination computer, without reliance on earlier exchanges between the given sender, the given receiver and a data communication network such as the Internet, coupling the given sender to the given receiver.

The present disclosure is concerned with data delivery systems and their methods of operation. According to an embodiment of the present invention, the system may utilize a SaaS video platform that provides data broadcasters with tools that are required to operate a video network on their own site. The system provides a streaming technology for reducing operating and bandwidth costs within a data communication network such as the Internet, when providing content data to one or more users, for example to a plurality of users as in multicasting. The platform corresponds to a data content delivery system, referred to as a “data waterfall” on account of an efficiency that it is operable to stream advertisement content data efficiently to users, that is able to provide, for example, multicasting services that are customized to users' browsing apparatuses in respect of advertisement content data delivery, based on technical operating characteristics of users' browsing apparatuses and/or most economically valuable (in terms of revenue generation) delivery of advertisement content data.

Many contemporary data content providers such as YOUTUBE®, RT® and similar providing program content data, employ a business model that requires advertisement content data to be delivered to users in return for payment from suppliers of the advertisement content data (namely “customers”); often, the program content data and the advertisement content data are presented concurrently to users. However, delivery of advertisement content data is provided from diverse sources with varying latency, and hence user experience of the program content data is often impaired as a result of the latency of the advertisement content data. Moreover, advertisement content data is conventionally provided via the Internet to users via data feeds that do not take into account technical characteristics of users' browsing apparatuses. As a result, considerable advertisement content data communicated via the Internet is conventionally wasted, and merely uses up data server arrangement capacity and data communication network bandwidth inefficiently. Such operation, in turn, results in sub-optimal commercial profits for data content providers.

Moreover, latency problems can be encountered when advertisement content data is provided in a form that is sub-optimal for users' computers, namely for users' browsing apparatuses. In contradiction, embodiments of the present disclosure are operable to employ an advertisement content data stack (“ad stack”) that is capable of substantially increasing advertisement monetization and this profitability per viewer, for example when advertisements are invoiced to advertisement content data providers on a basis of number of viewings by users.

Embodiments of the present disclosure provide a data delivery system including an advertisement content data server arrangement (“ad server”), for addressing contemporarily commonly-encountered performance issues, as well as increasing revenues, for example maximizing revenues, for advertising clients of the data delivery system. Such improvement is achieved by way of advanced technical features employed in the data delivery system and its manner of operation when supplying data to users. In other words, when supplying data to users, account is taken in respect of technical performance of users' browsing apparatuses and also supplying advertisement content data that is most suitable taking into account the technical performance as well as providing greatest revenue for operators of the embodiments when streaming advertisement content data provided by customers of the operators of the data delivery system. The data delivery system also allows clients of the data delivery system more easily to supply their own advertisement tags (“ad tags”) and enables deep integration of the advertisement tags within existing sites and software applications (“apps”).

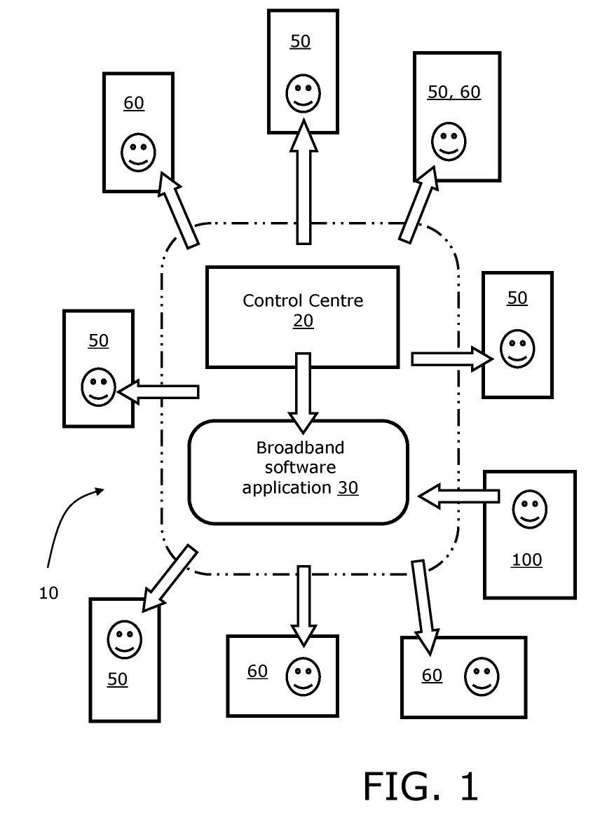

Referring to FIG. 1, a data delivery system is indicated generally by 10, and includes a control centre 20, such as a “LIQUIDSTREAM® Control Centre”, that is operable to function as a central access point for customers, allowing them to manage content, control advertising tasks and view analytics across their customer accounts. Moreover, the data delivery system 10 includes a broadcast software application 30, such as a “LIQUIDSTREAM® broadcast app”, that is implemented as a bespoke broadcast software application for providing customers with an ability to upload VOD files, namely “View on Demand” files (such as various types of advertisement content data files), to set up live data streams and to manage their workflow via a single, user-friendly interface from the convenience of their desktop computer, tablet computer, phablet computer, mobile wireless communication device or similar devices.

According to an embodiment of the present invention, the data delivery system 10 provides a platform that utilizes proprietary UDP/TCP video streaming methods and apparatuses that is capable of streaming vast amounts of data (for example, greater than 4 PB of data, namely >4 PB of data) across the World. Thus, the data delivery system 10 is capable of delivering higher quality video streams than has hitherto been possible using known data delivery approaches at comparable bitrates, as well as ensuring that advertisement content data is more economically beneficially and technically more efficiently delivered to users, for example with reduced temporal latency that represents a technical problem.

The data delivery system 10 provides an in-house ad-serving technology that provides clients with an ability to both monetize and monitor performance across their library of videos. Moreover, there is thereby provided flexibility to be able to support clients' (namely customers′) complex advertising requirements, while also increasing (namely, for example, maximising) revenue generated by optimising and dramatically streamlining an associated ad delivery process.

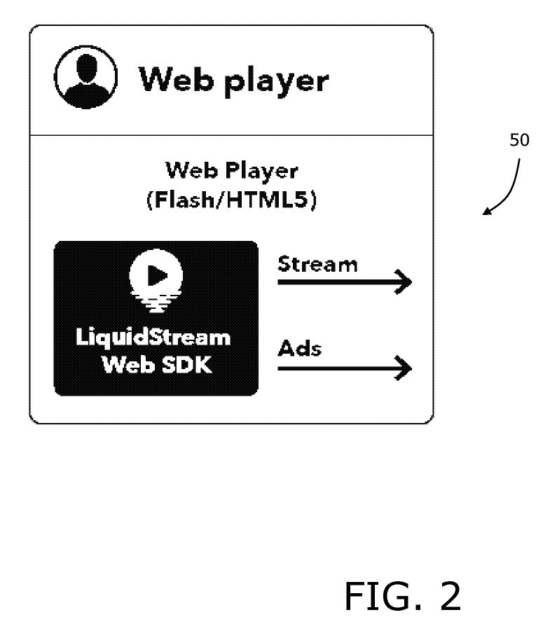

Referring next to FIG. 2, there is shown an illustration of a web player 50, for use with the data delivery system 10 of FIG. 1. The web player 50 is implemented as a software application, or a combination of customer digital hardware and a software application.

The web player 50 (for example, a “LIQUIDSTREAM® Web SDK”), provides clients, namely customers, with a fully functional video player that can be easily embedded into their Internet web sites, with advertisement content data delivery, video data playback via use of UDP and reporting included straight out-of-the-box. The web player 50 can also be integrated into third party players for increasing (namely, for example, maximizing) flexibility. The web player 50 is thus capable of supporting streaming of program content data and advertisement content data.

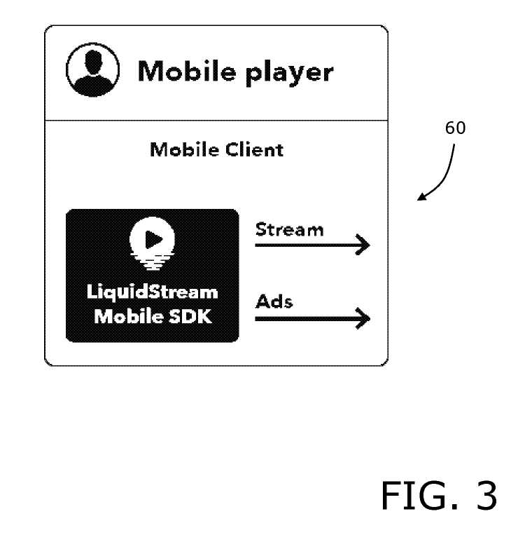

Referring next to FIG. 3, there is shown an illustration of a mobile player 60, for use with the data delivery system 10 of FIG. 1, when delivering data to mobile wireless communication devices, such as smart phones, that have smaller displays screens and less data processing capacity compared to stationary data processing apparatuses, for example desktop personal computers and laptop computers. The mobile player 60 is implemented as a software application, or a combination of customer digital hardware and a software application.

The mobile player 60 (for example, a “LIQUIDSTREAM® Mobile SDK”), provides mobile clients with a fully functional video player that can be easily embedded into their Internet web sites, with advertisement content data delivery, video data playback via use of UDP and reporting included straight out-of-the-box. The mobile player can also be integrated into third party players for increasing flexibility, for example maximizing flexibility. The mobile player 60 is thus capable of supporting streaming of program content data and advertisement content data. Moreover, the mobile player can be easily incorporated into clients' mobile apps, providing potentially seamless delivery of HTTP Live Streaming (“HLS”) content with reduced (for example, minimal) integration effort.

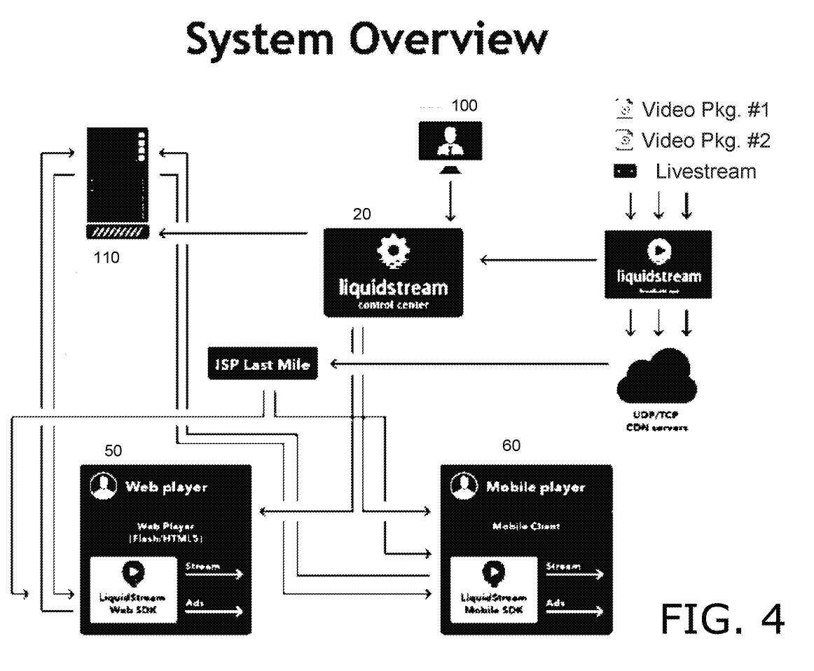

Referring next to FIG. 4, there are shown in greater detail functional elements of the data delivery system 10. The data delivery system 10 includes the aforementioned control centre 20, for coordinating operation of the data delivery system 10. The control centre 20 is operable to provide a customer interface to a customer 100, or optionally to a plurality of customers 100, for receiving customer instructions and also for receiving video metadata from the aforesaid broadcast app 30. The control centre 20 is operable to provide control instructions to the web player 50 and to the mobile player 60 as required. Moreover, the control centre 20 is operable to provide advertisements content data rules to a smart advertisement server 110 (for example, “LIQUIDSTREAM® smart ad server”).

In the data delivery system 10, video files and live streams, namely program content data, are provided to the broadcast app 30. The broadcast app 30 is operable to process the content data received thereat in operation, in real-time, and provide corresponding processed data to a UDP/TCP CDN server arrangement 120. The UDP/TCP CDN server arrangement 120, in turn, is operable to provide multicasted UDP data packets to an ISP Last Mile 130, namely a server and/or router in close spatial proximity to users. The ISP Last Mile 130 is operable to provide multicasted UDP data packets to the web player 50 and/or to the mobile player 60. The web player 50 and the mobile player 60 are operable to present program content data and/or advertisement content data to their corresponding users.

In operation, the web player 50 and the mobile player 60 are operable to provide analysis data therefrom to a smart advertisement content data server 140. The analysis data provides an indication of technical performance of the web player 50 and the mobile player 60, wherein the technical performance is determined, at least in part, by technical operating characteristics of computing hardware on which the web player 50 and/or the mobile player 60 are being executed. The analysis data provides an indication of one or more of:
(i) advertisement content data that can be most economically beneficially, in respect of an operator of the data delivery system 10, be delivered via the web player 50 to a given associated user;
(ii) a capability of the web player 50 and/or the mobile player 60 being executed on associated computing hardware of a given user to process received content data thereat (for example, whether or not there are media incompatibility issues, encoding format incompatibility issues or similar issues that prevent given content data from being rendered);
(iii) a capability of the web player 50 and/or the mobile player 60 being executed on associated computing hardware to buffer data thereat;
(iv) a degree of transcoding and/or reformatting needed, if relevant, in the web player 50 and/or the mobile player 60 to suit a native audio/video format of the computing hardware;
(v) a presentation resolution of the web player 50 and/or the mobile player 60 being executed on associated computing hardware when rendering program data content and/or advertisement data content;
(vi) one or more characteristics of a data communication network employed to provide content data, such as advertisement data content, to users; and
(vii) one or more user preferences entered by users into their respective computing hardware, namely content data browsing apparatus, for example image display resolution settings and similar.

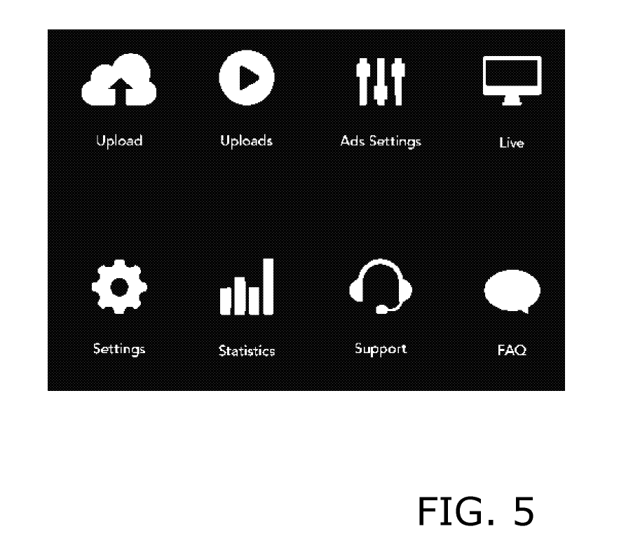

Referring next to FIG. 5, there is shown an illustration of a control panel displayed on a graphical user interface (GUI) of the aforementioned customer 100. The control panel provides several user-invoked options including:
(i) “Upload” for uploading advertisement content data and/or program content data onto the UDP/TCP CDN server arrangement 120;
(ii) “Uploads” for preview playing of content data uploaded by the customer 100;
(iii) “Ads Settings” for controlling various presentation data parameters for advertisement content data, such as frequency of presentation to other users of the data delivery system 10, resolution of presentation of the advertisement content data to other users of the data delivery system 10, display size of the advertisement content data to other users of the data delivery system 10, duration and commencement of period in which the advertisement content data is presented to other users of the data delivery system 10, and similar;
(iv) “Live” for activating given content data uploaded by the customer 100 onto the data delivery system 10;
(v) “Settings” for controlling various parameters of the GUI provided by the data delivery system to the customer 100;
(vi) “Statistics” for providing feedback to the customer 100 regarding numbers of viewing of advertisement content data and similar;
(vii) “Support” for invoking personal customer support provided automatically by the data delivery system 10, including via an avatar or actual customer support personnel; and
(viii) “FAQ” for providing other general user-support information regarding use and operation of the data delivery system 10.

Once approved, the customer 100 is able to access a portal of the data delivery system 10. The control panel of FIG. 5 provided a dashboard for providing the customer 100 with an overview of performance across their library of content. The customer 100 is able to access a support centre, as well as manage his/her content data and view analytics in the portal.

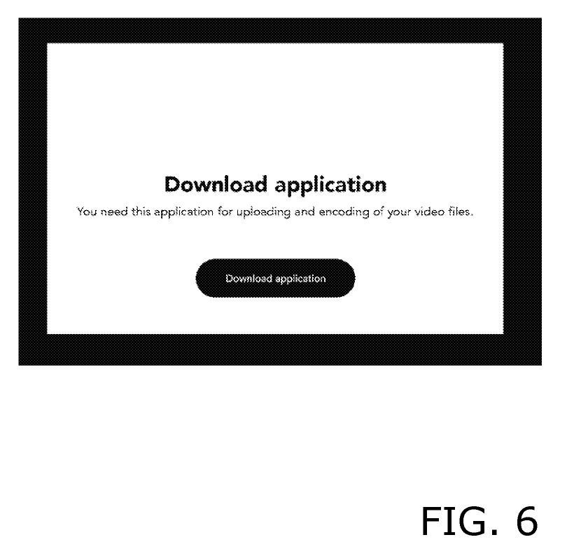

The portal of the graphical user interface (GUI) as provided in FIG. 5 is generated for the customer 100 by the customer 100 downloading a software application to a computing device (not shown), such as a desk-top personal computer (PC), laptop computer, tablet computer, or smart phone for example. Thus, to upload videos, the customer 100 simply downloads a Broadcast App from the portal through an interface which is depicted in FIG. 6.

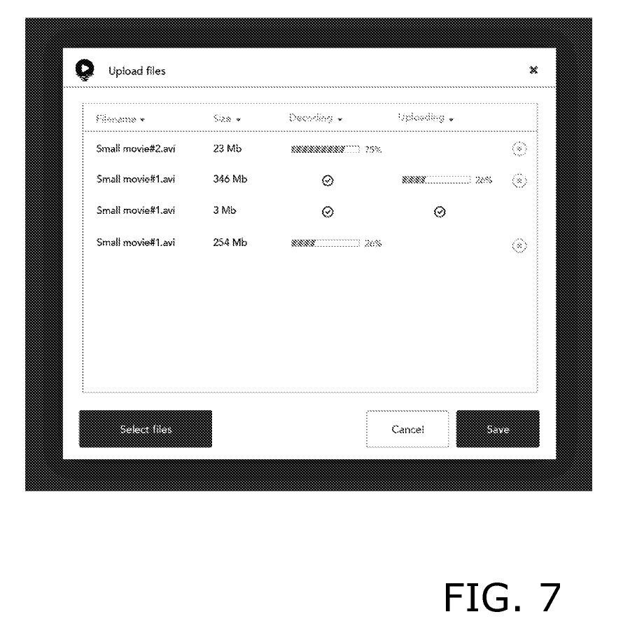

Referring next to FIG. 7, file uploading is implemented by the customer 100 using the Broadcast App from the portal. Following installation, the customer 100 logs into his/her account using his/her existing credentials. To upload videos, the customer 100 simply selects relevant desired files to be uploaded from data memory of the customer's 100 computing device, and then the application processes it.

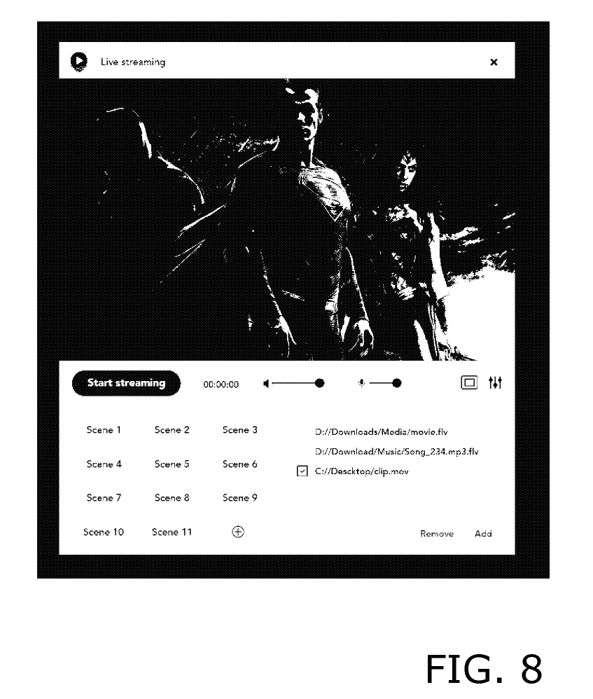

Referring next to FIG. 8, there is shown a Broadcast App interface, wherein the Broadcast App encodes and uploads files in parallel to deliver content data as quickly and efficiently as possible within the data delivery system 10, notifying the customer 100 when a queue of broadcast tasks instructed by the customer 100 has been processed.

In operation, the data delivery system 10 provides many benefits in comparison to known contemporary data delivery systems. Typically, advertisement content data supplied to users is often provided via TCP/IP, which has a complex protocol for ensuring data packets are received successfully by users. Moreover, advertisement data is often provided from a wide diversity of sources. Moreover, advertisement content data is often supplied to users in a form that is difficult for the user's computer to process, and in some cases not technically possible to process. As a result, a considerable amount of the data communicated is wasted, causing inefficient operation of the conventional Internet. It is estimated that approaching 50% of Internet data traffic is wasted, in that it either arrives late or is in an inappropriate form for users. Such wasted Internet® data traffic represents a technical problem because considerable energy and data network communication capacity is ineffectively utilized in association with a task of communicating data to users.

In contradistinction to known data delivery systems, the data delivery system 10 of the present disclosure uses the aforementioned analysis data from users to select advertisement content data that can be more efficiently processed by the users' computers. Thus, as aforementioned, in operation, the web player 50 and the mobile player 60 are operable to provide analysis data therefrom to a smart advertisement content data server 140. The analysis data provides an indication of technical performance of the web player 50 and the mobile player 60, wherein the technical performance is determined, at least in part, by technical operating characteristics of computing hardware on which the web player 50 and/or the mobile player 60 are being executed. As a result, advertisement content data supplied to and communicated within the data delivery system 10 is more suitable for users and is not wasted when received. Moreover, the data delivery system 10 is operable to supply advertisement content data 10 which is more rapidly available, rather than waiting for particular advertisement content data, so that the web player 50 and the mobile player 60 do not appear to the their users as “hanging up” or “freezing” (namely, paused) while waiting for particular advertisement content data to be received. User experience when executing the web player 50 and the mobile player 60 is thus improved, and advertisement content data communicated within the data delivery system 10 is more effectively utilized and more promptly delivered. As the data delivery system 10, like many conventional data delivery platforms, are dependent upon receiving advertisement income to cover operation of the platforms, more efficient delivery of advertisement content data within the data delivery system 10 is capable of increasing revenue-per-user, as well as decreasing an amount of data needed to be communicated within the data delivery system 10. The data delivery system 10 is thus capable of providing its operator with a higher average revenue per user (ARPU), thereby providing the operator with higher profits margins and with less data flow being required.

The data delivery system 10 is also operable to process data received form the customer 100 in real-time and load it directly to the UDP/TCP CDN server arrangement 120, ready for broadcasting to users; in contradistinction, known data delivery systems are operable to receive data from customers, store the received data in a database, then transcode the received data stored in the database to provide transcoded data in the database or other database, and thereafter access the transcoded data for broadcasting to users. The conventional transcoding of stored data represents inefficient server operation, and represents a considerable operation data processing overhead in convention data delivery systems.

From the foregoing, it will be appreciated that the ad server subsequently automatically analyzes and optimizes the delivery of campaigns to viewers (namely, “users”), in order to increase revenues (namely, for example, maximize revenues), for operators of the data delivery system 10. Moreover, an ad waterfall thereby provided is customised and optimised ‘on the fly’ per viewer, therefore resulting in less server requests being needed, and decreasing a risk of time-out.

In an embodiment of the present invention the user goes onto a website to watch video or other preferable content. In operation of the data delivery system 10, there are a plurality of data points, namely data parameters such as IP address, geographical location, browsing history, cookies, computer device type, and dozens of other data points, that are used to decide upon what content should be put in a slot on the website for a given user. The data points from viewers (namely, “users”), and algorithms that process associated data.

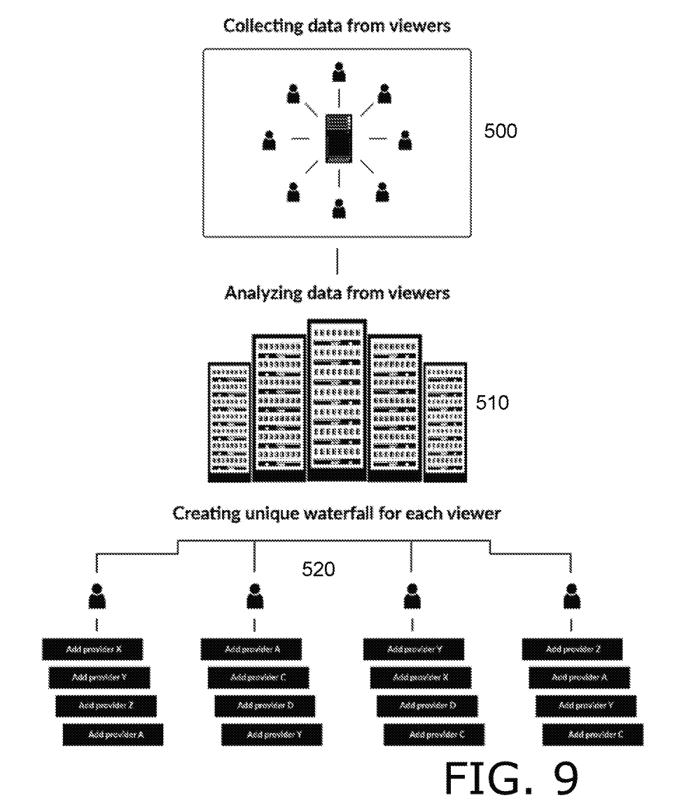

Referring next to FIG. 9, there are shown steps of a method of operating the data delivery system 10 of FIG. 1. In a first step 500, user datapoints are collected, for example physical datapoints (namely, not content targeted) per IP (Internet Protocol) address, metrics representative of a given user are thereby obtained. In a second step 510, the metrics are sent to a server that is operable to process the metrics; various rules and algorithms are applied to the metrics, including a profitability test. In a third step 520, there is determined a unique (namely, customized) data waterfall per unique user wherein a given user has a unique supply of content data, such as advertisement content data, from the content provider (namely, ad partner). Each user receives a unique waterfall of served content for that browsing session that is based on the most suitable data content that the content provider has available based on the user's calculated parameters. Even if the user comes back to a certain website shortly after leaving it, the user will get a unique waterfall of data content again.

Thus, in operation of an embodiment of the present invention, the data delivery system 10 chooses a best route regarding how to deliver content to a given user to increase fill rate and also to increase profitability to an operator of the data delivery system 10. The unique waterfall per user solves the fill rate issue because it displays the most suitable and profitable solution of data content to the user, which data content is requested from any one or more of the ad partners. Known standard approaches for providing a data waterfall are only typically capable of achieving a fill rate of around 25%. The standard approaches for providing a data waterfall is effected by the time out of the wrong ad partner's ad being requested (namely, called). In many cases the wrong content being requested results in no content (No Ad) being shown for the first content slot, the same for the second content slot and by the third content slot a time out occurs. The embodiments described solves this problem of no content being shown and resulting poor fill rate. However, in contradistinction, the data delivery system 10 is capable of achieving routinely a fill rate of 96% or more. Embodiments of the present disclosure are susceptible to being implemented in conjunction with Flash and HTML players, for example.

In operation of an embodiment of the present invention, IPs go into an embedded player that offers up slots to fill to advertising customers or partners. A match is then done of the slots and content data offered up by the advertisement customers or partners. Conventionally, in known data delivery systems, there is only achieved a 25% fill rate for the slots, as there is often a lack of a match between the slot and content data. Once a typical system has checked matching on a 1^{st} and 2^{nd} slot, by the time the system checks matching for a 3^{rd} slot or subsequent ones, the attempt times-out.

In contradistinction to known data delivery systems, the data delivery system 10 receives a given new user, wherein the new user's IP identification data is received by the given user's player; the player is operable to send a plurality of data points, back to a server whereat a plurality of algorithms, are run to determine most suitable content data to supply to the given user, after which there is sent a unique request of the most suitable content to fill the slot. One of the parameters computed by the twelve algorithms is profitability of the slot. As a result of taking profitability into account, it is feasible to achieve, for example, a 200% profitability improvement in comparison to known data delivery systems.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

Traditionally, a computer program consists of a finite sequence of computational instructions or program instructions. It will be appreciated that a programmable apparatus (namely, computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It will be appreciated that a given invention that employs a technical arrangement (namely, for example, an alternative data delivery system) to address one or more objective technical problems (namely, for example, data supply latency, data supply efficiency, reducing data supply network power dissipation) that have commercial benefits as well, does not suddenly render the given invention a business method as such (namely a common misunderstanding amongst Examiners at UKIPO and EPO). The present disclosure is primarily concerned with addressing objective technical problems of data communication within a data communication network.

In embodiments of the disclosure described in the foregoing, it will be appreciated that embodiments of the present disclosure provide a “data waterfall”. From a user/viewer perspective:
(i) the data waterfall queries an incoming user/IP of a specific user to determine certain physical parameters describing operation of the incoming user/IP;
(b) the data waterfall analyses data arising from the queries and chooses which demand partner/SSP/networks are to be used in operation to provide fill data for the specific user;
(c) the waterfall configures a data supply arrangement that is configured uniquely for the specific user/IP; and
(d) the data supply arrangement is configured to address a time-out problem that all known waterfalls currently exhibit, such that the data supply arrangement is operable to convert requests for data of any length, even in excess of 30 seconds.

From an advertisement (“ad”) side perspective:
(a) based upon the aforementioned certain physical parameters describing operation of the incoming user/IP, for example including CPM, fill rates, request latency and other parameters, the waterfall dynamically chooses a best demand partner from potentially hundreds of potential demand partners; and
(b) a selection of the best demand partner results in most efficient supply of content to the specific user, and also a highest profitability per user impression.

Embodiments of the present disclosure result in the data waterfall establishing a unique data supply arrangement of each user/IP. Moreover, the data waterfall is capable of accommodating an unlimited number of demand partners, whereas contemporary data supply arrangements are generally limited to only ten demand partners. Furthermore, the data waterfall functions in a horizontal manner and not in a manner of a known vertical data supply arrangement. Known contemporary data supply arrangements time out at 4 to 5 second, whereas the data waterfall of the present disclosure has no time-out limitation, thereby reducing wastage of data and reducing unnecessary energy dissipation as a result.

1. A data delivery system for providing multimedia content data to users, wherein the data delivery system comprises:
a data server arrangement for supplying the multimedia content data to users;
an advertisement content data server arrangement for providing advertisement content data to the users; and
a control centre arrangement for coordinating supply of the multimedia content data and the advertisement content data to the users, characterized in that:
the users have spatially local thereto computing hardware and associated display hardware for presenting the multimedia content data and the advertisement content data received at the users, wherein
the computing hardware is operable to execute program instructions for presenting the multimedia content data and the advertisement content data received at the users, the program instructions are operable to cause the computing hardware to report to the advertisement content data server arrangement an operating status and data processing capability of the computing hardware and associated display hardware, and
the advertisement content data server arrangement is operable to select advertisement data content for supplying to the users, customized for each user, depending upon the operating status and data processing capability, as well as a profitability associated with selecting the advertisement data content.

2. The data delivery system of claim 1, characterized in that the advertisement content data server arrangement is operable to employ an ad stack module for selecting the advertisement data content, wherein the operating status and data processing capability, as well as a profitability associated with selecting the advertisement data content, are indicative or one or more of:
(i) advertisement content data that can be most economically beneficially, in respect of an operator of the data delivery system, be delivered via the computing hardware and associated display hardware to a given associated user;
(ii) a capability of the program instructions, being executed on associated computing hardware to process received content data thereat, of presenting the multimedia content data and the advertisement content data received at the users whether or not there are media incompatibility issues or encoding format incompatibility issues that prevent given content data being presented;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

3. A data delivery system of claim 1, characterized in that the multimedia content data and the advertisement content data, when received at the data delivery system are processed in real-time at a broadcast application arrangement and stored in the data server arrangement.

4. A data delivery system claim 3, characterized in that the data delivery system provides in operation a customer-portal for enabling the customers to upload multimedia content data and/or advertisement content data via the broadcast application arrangement to the data server arrangement.

5. A data delivery system of claim 4, characterized in that the data delivery system provides in operation the customer-portal for enabling customers to review multimedia content data and/or advertisement content data that has been uploaded by the customers via the broadcast application arrangement (30) to the data server arrangement.

6. A data delivery system of claim 3, characterized in that the data delivery system is operable to collate and report statistical data representative of showings of multimedia content data and/or advertisement data, uploaded by the customers to the data delivery system, to the users.

7. A method of using a data delivery system for providing multimedia content data to users, wherein the data delivery system includes a data server arrangement for supplying the multimedia content data to the users, an advertisement content data server arrangement for providing advertisement content data to the users, and a control centre arrangement for coordinating supply of the multimedia content data and the advertisement content data to the users, characterized in that the method includes:
(i) arranging for the users to have spatially locally thereto computing hardware and associated display hardware for presenting the multimedia content data and the advertisement content data received at the users, wherein the computing hardware is operable to execute program instructions for presenting the multimedia content data and the advertisement content data received at the users; and
(ii) arranging for the program instructions to be operable to cause the computing hardware to report to the advertisement content data server arrangement an operating status and data processing capability of the computing hardware and associated display hardware, and the advertisement content data server arrangement to be operable to select advertisement data content for supplying to the users, customized for each user, depending upon the operating status and data processing capability, as well as a profitability associated with selecting the advertisement data content.

8. A method of claim 7, characterized in that the method includes arranging for the advertisement content data server arrangement to be operable to employ an ad stack module for selecting the advertisement data content, wherein the operating status and data processing capability, as well as a profitability associated with selecting the advertisement data content, are indicative or one or more of:
(i) an indication of advertisement content data that can be most economically beneficially, in respect of an operator of the data delivery system, be delivered via the computing hardware and associated display hardware to a given associated user;
(ii) a capability of the program instructions, for rendering and presenting the multimedia content data and the advertisement content data received at the users, being executed on associated computing hardware to process received content data thereat, whether or not there are media incompatibility issues, encoding format incompatibility issues that prevent given content data being rendered;
(iii) a capability of the of the program instructions being executed on associated computing hardware to buffer data thereat;
(iv) a degree of transcoding and/or reformatting required by the program instructions when executed to suit a native audio/video format of the computing hardware;
(v) a presentation resolution of the of the program instructions being executed on associated computing hardware when rendering multimedia data content and/or advertisement data content; and
(vi) one or more user preferences entered by users into their respective computing hardware.

9. A method of claim 7, characterized in that the multimedia content data and the advertisement content data, when received at the data delivery system are processed in real-time at a broadcast application arrangement and stored in the data server arrangement.

10. A method of claim 9, characterized in that the method includes arranging for the data delivery system to provide in operation a customer-portal for enabling the customers to upload multimedia content data and/or advertisement content data via the broadcast application arrangement to the data server arrangement.

11. A method of claim 10, characterized in that the method includes arranging for the data delivery system to provide in operation the customer-portal for enabling customers to review multimedia content data and/or advertisement content data that has been uploaded by the customers via the broadcast application arrangement to the data server arrangement.

12. A method of claim 9, characterized in that the method includes arranging for the data delivery system to be operable to collate and report statistical data representative of showings of multimedia content data and/or advertisement data, uploaded by the customers to the data delivery system, to the users.

13. An ad stack module for use with the data delivery system of claim 1, characterized in that the ad stack module is operable to select advertisement data content, in response to receiving data indicative of a given user operating status and data processing capability, as well as a profitability associated with selecting the advertisement data content for the given user, wherein the received data includes:
(i) an indication of advertisement content data that can be most economically beneficially, in respect of an operator of the data delivery system, be delivered via the computing hardware and associated display hardware to a given associated user;
(ii) a capability of the program instructions, for presenting the multimedia content data and the advertisement content data received at the users, being executed on associated computing hardware to process received content data thereat, whether or not there are media incompatibility issues, encoding format incompatibility issues that prevent given content data being presented;
(iii) program instructions being executed on associated computing hardware to buffer data thereat;
(iv) transcoding and/or reformatting required by the program instructions when executed to suit a native audio/video format of the computing hardware;
(v) a presentation resolution of the of the program instructions (50, 60) being executed on associated computing hardware when rendering multimedia data content and/or advertisement data content; and
(vi) one or more user preferences entered by users into their respective computing hardware.
